(19) United States
(12) Patent Application Publication
(10) Pub. No.: US 2010/0008340 A1
(43) Pub. Date: Jan. 14, 2010

(54) SYSTEM AND METHOD FOR IMPLEMENTING AN ORIGINAL CALL ANCHORING IN VOICE CALL CONTINUITY SERVICE

(75) Inventors: Zhendong Li, Guangdong Province (CN); Xiaofei Cao, Guangdong Province (CN); Weiduo Zhao, Guangdong Province (CN); Xiaolan Tang, Guangdong Province (CN)

Correspondence Address: BANNER & WITCOFF, LTD., 1100 13th STREET, N.W., SUITE 1200, WASHINGTON, DC, 20005-4051, US

(73) Assignee: ZTE CORPORATION, Shenzhen City, Guangdong (CN)

(21) Appl. No.: 12/438,807

(22) PCT Filed: Feb. 27, 2007
(86) PCT No.: PCT/CN07/00623

§ 371 Date: Feb. 25, 2009

(30) Foreign Application Priority Data
Aug. 31, 2006 (CN) 200610112750.3

(51) Int. Cl. H04W 8/02; H04L 12/66

(52) U.S. Cl. 370/338; 370/352

(57) ABSTRACT

The present invention offers a system and method for implementing an original call anchoring in voice call continuity service, and the system comprises the MSC/VLR, HLR, MGCF and VCC application server. A UE originates a call to the MSC/VLR in the CS domain, and the MSC/VLR sends the original request ORREQ message to the HLR, and then the HLR determines whether the UE has VCC service or not, if yes, it sends the message to the VCC application server which saves the information such as the called party number and returns the VCC application server number to the HLR after receiving the message sent by the HLR, and the HLR returns the VCC application server number back to the MSC/VLR through ORREQ response message; the MSC/VLR sends initial address message (IAM) including the VCC application server number to the MGCF, and the MGCF sends the INVITE message to the VCC application server number after it receives the IAM; the VCC application server obtains the called number and proceeds to the next-step call after it receives the INVITE message. The present invention achieves anchoring a call in the CS domain even if there is no intelligent network in the CS domain.

### TECHNICAL FIELD

The present invention relates to the field of mobile communication technology, and especially, to a method for anchoring a call when a VCC (Voice Call Continuity) user originates a call in the traditional domain without intelligent network services during the IMS (IP Multimedia Subsystem) network and the traditional network coexistent period.

### BACKGROUND ART

The core network of the mobile communication network has been evolving into the IMS of the ALL IP network. Since this evolution can not be completed in one day and it takes time for IMS of the ALL IP network to replace the present circuit switched domain network, there must be a situation that the IMS coexists with the traditional domain during the process.

For the network coverage, some areas are covered only by the traditional network; some other areas are covered only by the IMS network, while still others are covered by both of them. With the evolution of network, there will be more and more areas covered by the IMS network and fewer and fewer areas covered by the traditional network.

In this circumstance, the VCC (Voice Call Continuity) technology is developed, whose starting point is that the users have contracts with both networks and the terminal is also dual-mode. If the signal in one network is becoming poor during a voice call in the network while the signal in the other network is still good, the call is switched to the other network (for example, switching from the IMS network to the traditional domain network). During the process, the VCC technology should be used to ensure the continuity of the voice call.

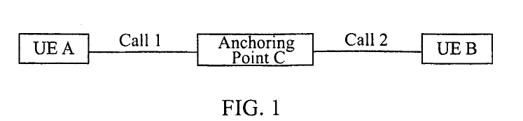

During the call, the support of anchoring technology is needed to ensure the continuity of the voice in the process of network switching. The anchoring means that one control point is inserted into the call path during the call, as shown in FIG. 1, thus the call between UE (User Equipment) A and UE B is divided into two calls: a call between UE A and Anchoring Point C and a call between Anchoring Point C and UE B. When the network switching happens at UE A, the call between the UE A and the Anchoring Point C will be re-established, while the call between the UE B and the Anchoring Point C will not be affected. Therefore, after the call between the UE A and the Anchoring Point C is re-established, the call between A and B can be continued and thus the voice call continuity is ensured.

In the following description, the call number of the UE who originates the call is referred to originating user number, while the call number of the UE who is called is referred to terminating user number.

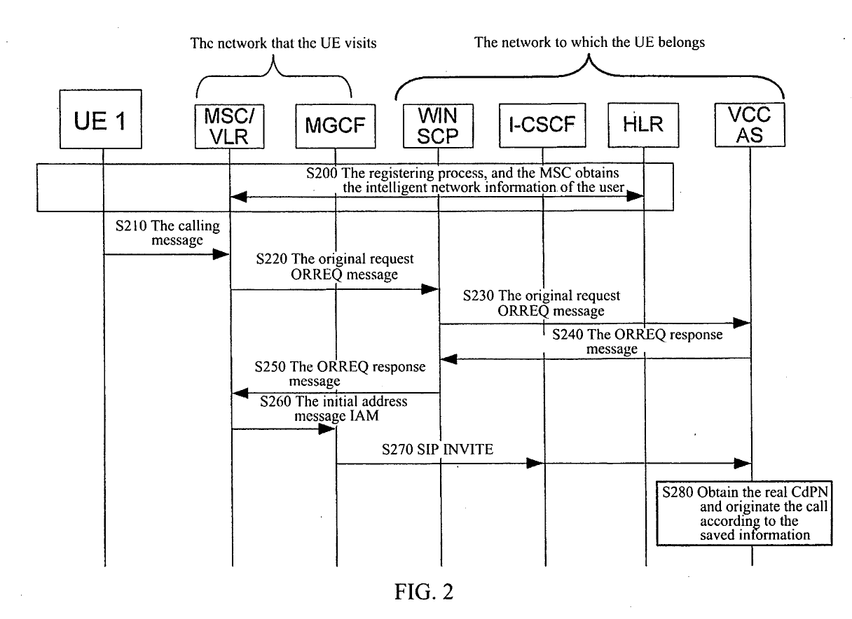

When a user originates a call in the CS (Circuit Switched) domain, the anchoring applies a method based on the intelligent network. The features of the method are shown in FIG. 2 (unrelated processes are omitted for simplification), and the method specifically comprises the following steps:

S200: when a UE registers in the CS domain, the MSC/VLR (Mobile Switching Centre/Visitor Location Register) obtains from the HLR (Home Location Register) the user's intelligent network information including the list of flip-flops, the address of the intelligent network SCP (Service Control Point), and so on;

S210: The UE originates a call in the CS domain, and in the message, the Calling Party Number (CgPN) is the originating user number and the Called Party Number (CdPN) is the terminating user number;

S220: The MSC/VLR sends the Original Request (ORREQ) message including the CgPN and CdPN to the WIN SCP (Wireless Intelligent Network Service Control Point) after it receives the call request according to the Intelligent Network flip-flops;

S230: After the WIN SCP receives the ORREQ message, it forwards it to the VCC AS (Application Server);

S240: the VCC AS saves the CgPN and CdPN after it receives the ORREQ message. In the returned ORREQ response message, the route message is set as the IMS route number of the VCC AS;

S250: The WIN SCP forwards the ORREQ message to the MSC/VLR;

S260: According to the route information (the IMS route number of the VCC AS) in the ORREQ message, the MSC/VLR sends ISUP [ISDN (Integrated Service Digital Network) User Part] IAM (Initial Address Message) call message in which the CgPN is still the calling party number while the CdPN is the IMS route number of the VCC AS to the MGCF (Media Gateway Control Function) of the network to which the UE belongs;

S270: After the MGCF receives the call, it sends the call request (SIP INVITE) to the I-CSCF (Call Session Control Function), and in SIP INVITE, the CgPN does not change while the CdPN is the IMS route number of the VCC AS. By inquiring the route, the I-CSCF sends the INVITE to the VCC AS;

S280: After the VCC AS receives the SIP INVITE, it finds out the real CdPN according to the CgPN in the message and the relationship between the CgPN and the CdPN saved in S240. The VCC AS continues to call using the real CdPNs;

Now the problem is that there is no intelligent service in many traditional networks. Thus the call anchoring in the CS domain can not be implemented in the VCC service.

### SUMMARY OF THE INVENTION

In order to overcome the above problem, the present invention offers a method and system for implementing an original call anchoring in voice call continuity service. It is to anchor a call to ensure the VCC service in the condition that there is no intelligent network in the Circuit Switched domain.

In order to achieve the above object, the present invention offers a system for implementing an original call anchoring in voice call continuity service, which is used to anchor to the VCC AS when a UE originates the call in the traditional domain without intelligent network service, the system includes:

Mobile Switching Centre/Visitor Location Register, used to send the original request ORREQ message to the Home Location Register and receive the ORREQ response message including the number of Voice Call Continuity Application Server returned from the Home Location Register after receiving the call from the UE; and used to send the Initial Address Message in which the Called Party Number is the number of the Voice Call Continuity Application Server to the Media Gateway Control Function;

Home Location Register, used to determine whether the UE who originates the call has the Voice Call Continuity service or not according to the received original request ORREQ message, if yes, send the message to the Voice Call Continuity Application Server and receive the response message including the number of the Voice Call Continuity Application Server returned from the Voice Call Continuity Application Server, and forward the number of the Voice Call Continuity Application Server to the Mobile Switching Centre/Visitor Location Register through the ORREQ response message;

Voice Call Continuity Application Server, used to return the message including the number of the Voice Call Continuity Application Server to the Home Location Register after receiving and saving the message sent by the Home Location Register, and originate a call to the UE according to the saved message after receiving the INVITE message forwarded by the Inquiry-Call Session Control Function;

Media Gateway Control Function, used to receive the Initial Address Message and send INVITE message to the Inquiry-Call Session Control Function according to the Called Party Number in the Initial Address message;

Inquiry-Call Session Control Function, used to receive the INVITE message from the Media Gateway Control Function and forward the message to the Voice Call Continuity Application Server after inquiring the route.

Furthermore, the system also includes a UE used to originate a call to the Mobile Switching Centre/Visitor Location Register in the Circuit Switched domain.

Furthermore, the message sent to the Voice Call Continuity Application Server by the Home Location Register is an original request ORREQ message or a route request ROUTREQ message;

Correspondingly, the Voice Call Continuity Application Server returns an ORREQ response message or a route request ROUTREQ message to the Home Location Register; the returned message includes the number of the Voice Call Continuity Application Server.

Furthermore, when the UE registers in the Circuit Switched domain, the Mobile Switching Centre/Visitor Location Register obtains and saves the calling flip-flop of the UE from the Home Location Register; and the Mobile Switching Centre/Visitor Location Register determines whether to send the original request ORREQ message to the Home Location Register or not according to the saved calling flip-flop after it receives the call from the UE; if yes, it sends the message.

The present invention also offers a method for implementing an original call anchoring in voice call continuity service, which is used to anchor to the Voice Call Continuity Application Server when the UE originates a call in the traditional domain without the intelligent network service, and the method includes the following steps:

Step 1, a UE originates a call to Mobile Switching Centre/Visitor Location Register;

Step 2, the Mobile Switching Centre/Visitor Location Register sends an original request ORREQ message to Home Location Register after it receives the call from the UE;

Step 3, the Home Location Register determines whether the UE has Voice Call Continuity service or not, if yes, it sends the message to Voice Call Continuity Application Server;

Step 4, the Voice Call Continuity Application Server returns a response message including the number of the Voice Call Continuity Application Server to the Home Location Register after it receives and saves the message send by the Home Location Register;

Step 5, The Home Location Register returns the number of the Voice Call Continuity Application Server to the Mobile Switching Centre/Visitor Location Register through the ORREQ response message;

Step 6, the Mobile Switching Centre/Visitor Location Register sends Initial Address Message in which the Called Party Number is the number of the Voice Call Continuity Application Server to Media Gateway Control Function;

Step 7, the Media Gateway Control Function sends INVITE message to the Inquiry-Call Session Control Function after it receives the Initial Address Message;

Step 8, the Inquiry-Call Session Control Function forwards the INVITE message to the Voice Call Continuity Application Server after it inquires the route;

Step 9, the Voice Call Continuity Application Server proceeds to the next-step call according to the message saved in step 4 after it receives the INVITE message.

Furthermore, before step 1, there is also the following step:

When the UE registers in the Circuit Switched domain, the Mobile Switching Centre/Visitor Location Register obtains and saves the calling flip-flop of the LE from the Home Location Register.

Furthermore, said step 2 specifically includes the following steps:

Step 21, after the Mobile Switching Centre/Visitor Location Register receives the call from the UE, it determines whether to send the original request ORREQ message to the Home Location Register or not according to the saved calling flip-flop;

Step 22, if yes, it sends the original request ORREQ message to the Home Location Register.

Furthermore, in step 3, the message sent to the Voice Call Continuity Application Server by the Home Location Register is the original request ORREQ message; in step 4, the Voice Call Continuity Application Server returns the ORREQ response message including the number of the Voice Call Continuity Application Server number to the Home Location Register.

Furthermore, in step 3, the message sent to the Voice Call Continuity Application Server by the Home Location Register is route request ROUTREQ message; in step 4, the Voice Call Continuity Application Server returns ROUTREQ response message including the number of the Voice Call Continuity Application Server to the Home Location Register.

Furthermore, the method is specified as:

Step 71, the UE sends a call to the Mobile Switching Centre with/Visitor Location Register with the Calling Party Number being the originating user number and the Called Party Number being the terminating user number;

Step 72, the Mobile Switching Centre/Visitor Location Register sends original request ORREQ message including the Calling Party Number and Called Party Number to the Home Location Register;

Step 73, the Home Location Register sends route request ROUTREQ message or original request ORREQ message including the Calling Party Number and the Called Party Number to the Voice Call Continuity Application Server;

Step 74, the Voice Call Continuity Application Server saves the Calling Party Number and Called Party Number and returns the ROUTREQ response message or the ORREQ response message including the number of the Voice Call Continuity Application Server to the Home Location Register;

Step 75, the Home Location Register returns the ORREQ response message including the number of the Voice Call Continuity Application Server to the Mobile Switching Centre/Visitor Location Register;

Step 76, the Mobile Switching Centre/Visitor Location Register sends the Initial Address Message to the Media Gateway Control Function, and in the Initial Address Message, the Calling Party Number is the originating user number, and the Called Party Number is changed to the number of the Voice Call Continuity Application Server;

Step 77, the Media Gateway Control Function sends the INVITE message including the Calling Party Number and the Called Party Number to the Inquiry-Call Session Control Function according to the Called Party Number in the Initial Address Message;

Step 78, after the Inquiry-Call Session Control Function inquires the route, it forwards the INVITE message to the Voice Call Continuity Application Server;

Step 79, the Voice Call Continuity Application Server finds out the corresponding terminating user number according to the Calling Party Number in the INVITE message and the relationship between the Calling Party Number and Called Party Number saved in step 74, and continues to call according to said terminating user number.

Furthermore, the number of the Voice Call Continuity Application Server is the IP Multimedia Subsystem (IMS) route number of the Voice Call Continuity Application Server.

The advantage of the present invention is that it solves the problem of anchoring the call in the VCC service in the Circuit Switched domain without intelligent network. The feature of the method is to make the process consistent with the mode of intelligent network as much as possible, thus there is no modification for the Voice Call Continuity Application Server and little modification for the Home Location Register.

### BRIEF DESCRIPTION OF THE PRESENT INVENTION

FIG. 1 illustrates how to anchor a call in the prior art;

FIG. 2 illustrates a process of anchoring a call in the CS domain in the present intelligent network scheme;

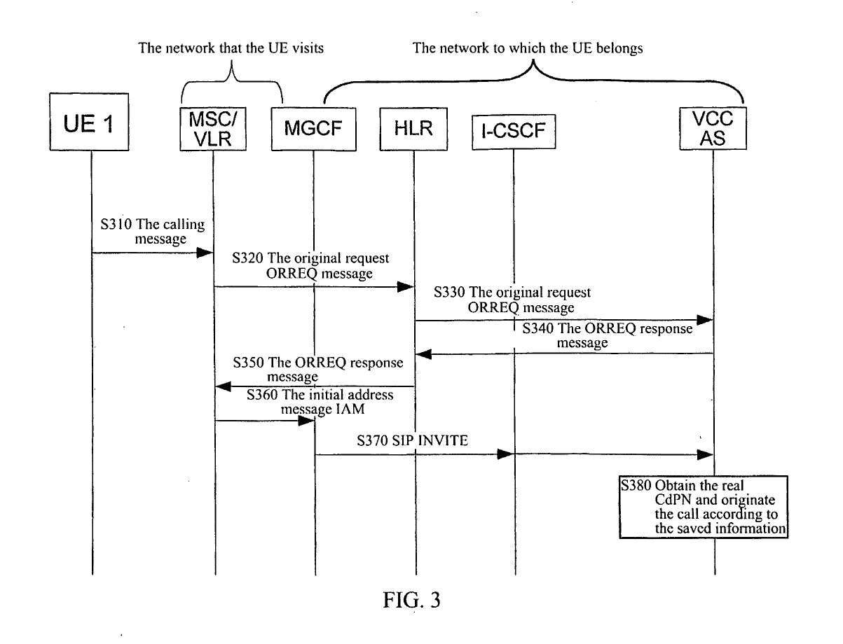

FIG. 3 illustrates an embodiment of the method for implementing an original call anchoring in voice call continuity service in accordance with the present invention;

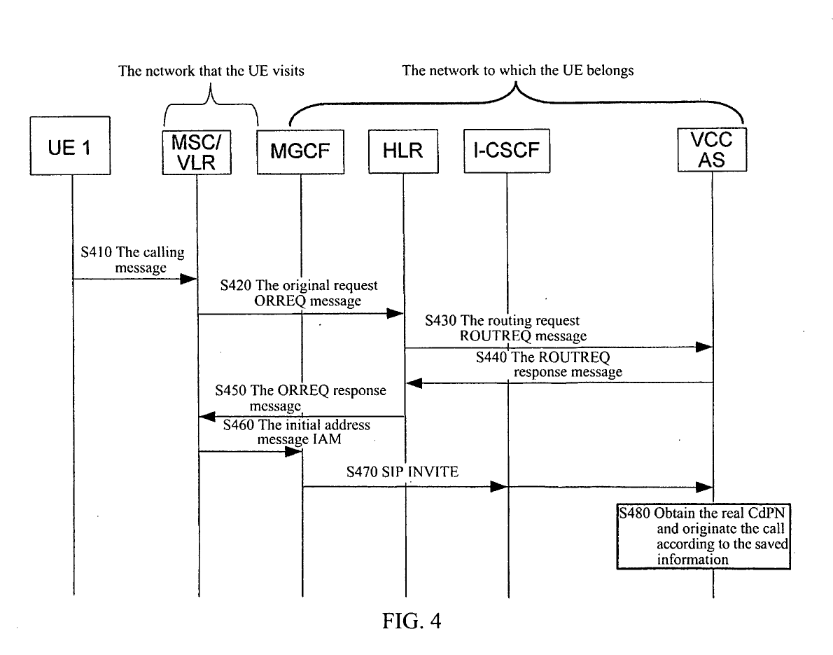

FIG. 4 illustrates another embodiment of the method for implementing an original call anchoring in voice call continuity service in accordance with the present invention.

### PREFERRED EMBODIMENTS OF THE PRESENT INVENTION

In the following, the present invention will be described in further detail with the combination of the accompanying figures and the embodiments.

A system for implementing an original call anchoring in voice call continuity service, includes:

MSC/VLR, used to send the ORREQ message including the CgPN and CdPN to the HLR and receive the ORREQ response message including the VCC AS number returned from the HLR after it receives the call originated by the UE in the CS domain; and used to send the IAM in which the CdPN is the VCC AS number to the MGCF;

HLR, used to determine whether the UE has the VCC service or not according to the received ORREQ message, if yes, it sends the ORREQ message or the ROUTREQ message to the VCC AS, receives the returned response message including the VCC AS number returned from the VCC AS, and forwards the VCC AS number to the MSC/VLR through the ORREQ response message;

VCC AS, used to return a message including the VCC AS number to the HLR after it receives and saves the message sent by the HLR, and to originate a call to the UE according to the saved message after it receives the INVITE message forwarded by the I-CSCF;

MGCF, used to receive the IAM and send INVITE message to the I-CSCF according to the CdPN in the IAM;

I-CSCF, used to receive the INVITE message sent from the MGCF and forward the INVITE message to the VCC AS after inquiring the route.

Furthermore, the system may also include a UE used to originate a call to the MSC/VLR in the CS domain.

The present invention also offers a method for anchoring a call in the VCC service.

The UE in the traditional domain anchors to the VCC AS when it originates a call. When the UE who originates the call registers in the CS domain, the MSC/VLR obtains and saves the related parameters including the list of calling flip-flops of the UE from the HLR.

FIG. 3 illustrates a signaling process of the present invention, in which the message sent to the VCC AS by the HLR is the ORREQ message, and the process includes the following steps:

S310, the calling message of the UE who originates the call in the CS domain arrives at the MSC/VLR;

S320, the MSC/VLR determines whether to send the ORREQ message to the HLR or not according to the users' contract information, i.e., the saved calling flip-flop; if yes, it sends the ORREQ message in which the CgPN is the calling party number and the CdPN is the called party number to the HLR;

S330, after the HLR receives the ORREQ message, it determines whether the UE has the VCC service or not, if yes, it forwards the ORREQ message to the VCC AS;

S340, After the VCC AS receives the ORREQ message, it saves the CgPN and CdPN and returns the ORREQ response message including the route information, i.e. the IMS route number of the VCC AS, to the HLR;

S350, The HLR forwards the received ORREQ response message to the MSC/VLR;

S360, the MSC/VLR sends the ISUP IAM in which the CgPN is not changed while the CdPN is the IMS route number of the VCC AS received in the ORREQ to the MGCF of the network to which the originating UE belongs or which the originating UE visits according to the received route information (the IMS route number of the VCC AS) in the ORREQ response message;

S370, after it receives the IAM, the MGCF sends INVITE message to the I-CSCF according to the CdPN, i.e. the IMS route number of the VCC AS, in the IAM, and in the INVITE message, the CgPN is not changed and the CdPN is the IMS route number of the VCC AS. After the I-CSCF receives the INVITE message, it inquires the route and forwards the INVITE message to the VCC AS;

S380, after the VCC AS receives the INVITE message, it finds out the real terminating user number according to the CgPN in the message and the relationship between the CgPN and CdPN (terminating user number) saved in S340. The VCC AS continues to call according to the real terminating user number.

FIG. 4 illustrates another signaling process of the present invention, in which the message sent to the VCC AS by the HLR is the ROUTREQ message, and the process includes the following steps:

S410, the calling message in the CS domain arrives at the MSC/VLR;

S420, the MSC/VLR sends the ORREQ message in which the CgPN is the originating user number and the CdPN is the terminating user number to the HLR according to the users' contract information;

S430, after the HLR receives the ORREQ message, it determines whether the UE has the VCC service or not according to the contract information and configuration of the UE, if yes, it sends ROUTREQ message including the CgPN and CdPN received in ORREQ message to the VCC AS;

S440, After the VCC AS receives the ROUTREQ message, it saves the CgPN and CdPN and returns the ROUTREQ response message including the route information, i.e. the IMS route number of the VCC AS, to the HLR;

S450, The HLR sends the ORREQ response message in which the route information is the IMS route number of the VCC AS to the MSC/VLR;

S460, the MSC/VLR sends the ISUP IAM in which the CgPN is not changed while the CdPN is the number received in ORREQ (the IMS route number of the VCC AS) to the MGCF of the network to which the UE belongs or which the UE visits according to the route information (the ISM route number of the VCC AS) received in the ORREQ response message;

S470, after it receives the IAM, the MGCF sends the INVITE message to the I-CSCF according to the CdPN (the IMS route number of the VCC AS), and in the INVITE message, the CgPN is not changed and the CdPN is the IMS route number of the VCC AS. After the I-CSCF receives the INVITE message, it inquires the route and forwards the INVITE message to the VCC AS;

S480, after the VCC AS receives the INVITE message, it finds out the real terminating user number according to the CgPN in the message and the relationship between the CgPN and CdPN saved in S440. The VCC AS continues to call according to the real terminating number.

Of course, the present invention may have many other embodiments. Therefore, without departing from the spirit and essence of the present invention, those skilled in the field can make all kinds of modification or variations, which should fall into the scope of the claims of the present invention.

### INDUSTRIAL APPLICABILITY

The present invention implements call anchoring to ensure the VCC service in the condition that there is no intelligent network in the CS domain; Moreover, the process of the method in accordance with the present invention is consistent with the mode of the intelligent network as much as possible, thus there is no modification for the VCC AS in the system and little modification for the HLR.

1. A system for implementing an original call anchoring in voice call continuity service, used to anchor to a Voice Call Continuity Application Server when a User Equipment originates a call in a traditional domain without an intelligent network service, wherein the system comprises:
Mobile Switching Centre/Visitor Location Register, used to send an original request ORREQ message to Home Location Register and receive an ORREQ response message including a number of Voice Call Continuity Application Server returned from the Home Location Register after receiving the call from the User Equipment; and used to send an Initial Address Message in which a Called Party Number is the number of the Voice Call Continuity Application Server to Media Gateway Control Function;
Home Location Register, used to determine whether the User Equipment who originates the call has the Voice Call Continuity service or not according to the received original request ORREQ message, if yes, send the message to the Voice Call Continuity Application Server and receive the response message including the number of the Voice Call Continuity Application Server returned from the Voice Call Continuity Application Server, and forward the number of the Voice Call Continuity Application Server to the Mobile Switching Centre/Visitor Location Register through the ORREQ response message;
Voice Call Continuity Application Server, used to return the message including the number of the Voice Call Continuity Application Server to the Home Location Register after receiving and saving the message sent by the Home Location Register, and originate a call to the User Equipment according to the saved message after receiving an INVITE message forwarded by Inquiry-Call Session Control Function;
Media Gateway Control Function, used to receive the Initial Address Message and send the INVITE message to the Inquiry-Call Session Control Function according to the Called Party Number in the Initial Address message;
Inquiry-Call Session Control Function, used to receive the INVITE message from the Media Gateway Control Function and forward the message to the Voice Call Continuity Application Server after inquiring a route.

2. The system of claim 1, wherein the system further includes:
User Equipment, used to originate the call to the Mobile Switching Centre/Visitor Location Register in a Circuit Switched domain.

3. The system of claim 1, wherein:
the message sent to the Voice Call Continuity Application Server by the Home Location Register is the original request message or a route request ROUTREQ message;
the Voice Call Continuity Application Server returns the ORREQ response message or the route request ROUTREQ message to the Home Location Register correspondingly; the returned message includes the number of the Voice Call Continuity Application Server.

4. The system of claim 1, wherein:
when the User Equipment registers in the Circuit Switched domain, the Mobile Switching Centre/Visitor Location Register obtains and saves a calling flip-flop of the User Equipment from the Home Location Register, determines whether to send the original request ORREQ message to the Home Location Register or not according to the saved calling flip-flop after receiving the call from the User Equipment; if yes, the Mobile Switching Centre/Visitor Location Register sends the message.

5. A method for implementing an original call anchoring in voice call continuity service, used to anchor to a Voice Call Continuity Application Server when a User Equipment originates a call in a traditional domain without an intelligent network service, wherein the method comprises the following steps:
Step 1, the User Equipment originating a call to a Mobile Switching Centre/Visitor Location Register;
Step 2, the Mobile Switching Centre/Visitor Location Register sending an original request ORREQ message to a Home Location Register after receiving the call from the User Equipment;
Step 3, the Home Location Register determining whether the User Equipment has Voice Call Continuity service or not, if yes, sending the message to Voice Call Continuity Application Server;
Step 4, the Voice Call Continuity Application Server returning a response message including a number of the Voice Call Continuity Application Server to the Home Location Register after receiving and saving the message send by the Home Location Register;
Step 5, The Home Location Register returning the number of the Voice Call Continuity Application Server to the Mobile Switching Centre/Visitor Location Register through an ORREQ response message;
Step 6, the Mobile Switching Centre/Visitor Location Register sending an Initial Address Message in which a Called Party Number is the number of the Voice Call Continuity Application Server to Media Gateway Control Function;
Step 7, the Media Gateway Control Function sending an INVITE message to Inquiry-Call Session Control Function after receiving the Initial Address Message;
Step 8, the Inquiry-Call Session Control Function forwarding the INVITE message to the Voice Call Continuity Application Server after inquiring a route;
Step 9, the Voice Call Continuity Application Server proceeding to a next-step call according to the message saved in step 4 after receiving the INVITE message.

6. The method of claim 5, wherein before step 1, there is further the following step:
when the User Equipment registers in a Circuit Switched domain, the Mobile Switching Centre/Visitor Location Register obtaining and saving a calling flip-flop of the User Equipment from the Home Location Register.

7. The method of claim 6, wherein said step 2 comprises the following steps:
Step 21, after receiving the call from the User Equipment, the Mobile Switching Centre/Visitor Location Register determining whether to send the original request ORREQ message to the Home Location Register or not according to the saved calling flip-flop;
Step 22, if yes, the Mobile Switching Centre/Visitor Location Register sending the original request ORREQ message to the Home Location Register.

8. The method of claim 5, wherein in step 3, the message sent to the Voice Call Continuity Application Server by the Home Location Register is the original request ORREQ message; in step 4, the Voice Call Continuity Application Server returns the ORREQ response message including the number of the Voice Call Continuity Application Server to the Home Location Register.

9. The method of claim 5, wherein in step 3, the message sent to the Voice Call Continuity Application Server by the Home Location Register is a route request ROUTREQ message; in step 4, the Voice Call Continuity Application Server returns ROUTREQ response message including the number of the Voice Call Continuity Application Server to the Home Location Register.

10. The method of claim 5, wherein the method comprises:
Step 71, the User Equipment sending a call to the Mobile Switching Centre with/Visitor Location Register with a Calling Party Number being an originating user number and the Called Party Number being a terminating user number;
Step 72, the Mobile Switching Centre/Visitor Location Register sending original request ORREQ message including the Calling Party Number and the Called Party Number to the Home Location Register;
Step 73, the Home Location Register sending route request ROUTREQ message or original request ORREQ message including the Calling Party Number and the Called Party Number to the Voice Call Continuity Application Server;
Step 74, the Voice Call Continuity Application Server saving the Calling Party Number and the Called Party Number and returning the ROUTREQ response message or the ORREQ response message including the number of the Voice Call Continuity Application Server to the Home Location Register;
Step 75, the Home Location Register returning the ORREQ response message including the number of the Voice Call Continuity Application Server to the Mobile Switching Centre/Visitor Location Register;
Step 76, the Mobile Switching Centre/Visitor Location Register sending the Initial Address Message in which the Calling Party Number is the originating user number and the Called Party Number is changed to the number of the Voice Call Continuity Application Server to the Media Gateway Control Function;
Step 77, the Media Gateway Control Function sending the INVITE message including the Calling Party Number and the Called Party Number to the Inquiry-Call Session Control Function according to the Called Party Number in the Initial Address Message;
Step 78, after inquiring the route, the Inquiry-Call Session Control Function forwarding the INVITE message to the Voice Call Continuity Application Server;
Step 79, the Voice Call Continuity Application Server finding out the corresponding terminating user number according to the Calling Party Number in the INVITE message and a relationship between the Calling Party Number and the Called Party Number saved in step 74, and continuing to call according to said terminating user number.

11. The method of claim 5, wherein the number of the Voice Call Continuity Application Server is an IP Multimedia Subsystem route number of the Voice Call Continuity Application Server.

12. The method of claim 8, wherein the method comprises:
Step 71, the User Equipment sending a call to the Mobile Switching Centre with/Visitor Location Register with a Calling Party Number being an originating user number and the Called Party Number being a terminating user number;
Step 72, the Mobile Switching Centre/Visitor Location Register sending original request ORREQ message including the Calling Party Number and the Called Party Number to the Home Location Register;
Step 73, the Home Location Register sending route request ROUTREQ message or original request ORREQ message including the Calling Party Number and the Called Party Number to the Voice Call Continuity Application Server;
Step 74, the Voice Call Continuity Application Server saving the Calling Party Number and the Called Party Number and returning the ROUTREQ response message or the ORREQ response message including the number of the Voice Call Continuity Application Server to the Home Location Register;
Step 75, the Home Location Register returning the ORREQ response message including the number of the Voice Call Continuity Application Server to the Mobile Switching Centre/Visitor Location Register;
Step 76, the Mobile Switching Centre/Visitor Location Register sending the Initial Address Message in which the Calling Party Number is the originating user number and the Called Party Number is changed to the number of the Voice Call Continuity Application Server to the Media Gateway Control Function;
Step 77, the Media Gateway Control Function sending the INVITE message including the Calling Party Number and the Called Party Number to the Inquiry-Call Session Control Function according to the Called Party Number in the Initial Address Message;
Step 78, after inquiring the route, the Inquiry-Call Session Control Function forwarding the INVITE message to the Voice Call Continuity Application Server;
Step 79, the Voice Call Continuity Application Server finding out the corresponding terminating user number according to the Calling Party Number in the INVITE message and a relationship between the Calling Party Number and the Called Party Number saved in step 74, and continuing to call according to said terminating user number.

13. The method of claim 9, wherein the method comprises:
Step 71, the User Equipment sending a call to the Mobile Switching Centre with/Visitor Location Register with a Calling Party Number being an originating user number and the Called Party Number being a terminating user number;
Step 72, the Mobile Switching Centre/Visitor Location Register sending original request ORREQ message including the Calling Party Number and the Called Party Number to the Home Location Register;
Step 73, the Home Location Register sending route request ROUTREQ message or original request ORREQ message including the Calling Party Number and the Called Party Number to the Voice Call Continuity Application Server;
Step 74, the Voice Call Continuity Application Server saving the Calling Party Number and the Called Party Number and returning the ROUTREQ response message or the ORREQ response message including the number of the Voice Call Continuity Application Server to the Home Location Register;
Step 75, the Home Location Register returning the ORREQ response message including the number of the Voice Call Continuity Application Server to the Mobile Switching Centre/Visitor Location Register;
Step 76, the Mobile Switching Centre/Visitor Location Register sending the Initial Address Message in which the Calling Party Number is the originating user number and the Called Party Number is changed to the number of the Voice Call Continuity Application Server to the Media Gateway Control Function;
Step 77, the Media Gateway Control Function sending the INVITE message including the Calling Party Number and the Called Party Number to the Inquiry-Call Session Control Function according to the Called Party Number in the Initial Address Message;
Step 78, after inquiring the route, the Inquiry-Call Session Control Function forwarding the INVITE message to the Voice Call Continuity Application Server;
Step 79, the Voice Call Continuity Application Server finding out the corresponding terminating user number according to the Calling Party Number in the INVITE message and a relationship between the Calling Party Number and the Called Party Number saved in step 74, and continuing to call according to said terminating user number.
